(19) United States
(12) Patent Application Publication
(10) Pub. No.: US 2010/0155581 A1
(43) Pub. Date: Jun. 24, 2010

(54) LASER SCANNING UNIT AND IMAGE-FORMING APPARATUS HAVING THE SAME

(75) Inventor: HEE-SUNG CHO, SUWON-SI (KR)

Correspondence Address: STANZIONE & KIM, LLP, 919 18TH STREET, N.W., SUITE 440, WASHINGTON, DC, 20006, US

(73) Assignee: SAMSUNG ELECTRONICS CO., LTD., SUWON-SI (KR)

(21) Appl. No.: 12/578,657

(22) Filed: Oct. 14, 2009

(30) Foreign Application Priority Data
Dec. 23, 2008 (KR) 2008-0132511

(51) Int. Cl. H01J 40/14

(52) U.S. Cl. 250/225

(57) ABSTRACT

A laser scanning unit and an image-forming apparatus employing the laser scanning unit. The laser scanning unit includes an optical source to irradiate a light beam, a deflector to deflect the irradiated light beam to a photosensitive body, an optical imaging device on which the light beam deflected from the deflector is incident and which forms an image on the photosensitive body, and an optical reflective device to deflect the light beam transmitted through the optical imaging device toward the optical imaging device, wherein the light beam incident on the optical imaging device includes P polarized light and S polarized light, such that the proportion of P polarized light is greater than the proportion of S polarized light.

### CROSS-REFERENCE TO RELATED APPLICATIONS

This application claims the benefit of priority under 35 U.S.C. §119(a) from Korean Patent Application No. 10-2008-0132511, filed on Dec. 23, 2008, in the Korean Intellectual Property Office, the disclosure of which is incorporated herein by reference in its entirety.

### BACKGROUND

1. Field of the Invention

The present general inventive concept relates to an image forming apparatus having a laser scanning unit, and, more particularly, to a laser scanning unit having brightness ratio uniformity and an image-forming apparatus including the laser scanning unit.

2. Description of the Related Art

Laser scanning units are used in image-forming apparatuses such as laser beam printers (LBP) and digital copiers and form electrostatic latent images by irradiating a laser beam to a photosensitive body. A laser scanning unit periodically deflects a light beam converted according to an image signal to the photosensitive body using a deflector, for example, a polygonal mirror. Also, the laser scanning unit focuses the deflected laser beam onto the photosensitive body using an optical imaging device and forms an electrostatic latent image.

### SUMMARY

One of the elements in an image-forming apparatus which affect printing quality is the laser scanning unit. Therefore, performance of the laser scanning unit needs to be improved so as to improve image quality of the image-forming apparatus.

The present general inventive concept provides a laser scanning unit having brightness ratio uniformity.

The present general inventive concept also provides an image-forming apparatus having brightness ratio uniformity and thus has improved image quality.

Additional features and utilities of the present general inventive concept will be set forth in part in the description which follows and, in part, will be obvious from the description, or may be learned by practice of the general inventive concept.

Embodiments of the present general inventive concept can be achieved by providing a laser scanning unit including an optical source to irradiate a light beam, a deflector to deflect the irradiated light beam to a photosensitive body, an optical imaging device on which the light beam deflected from the deflector is incident and which forms an image on the photosensitive body, and an optical reflective device to reflect the deflected light beam transmitted through the optical imaging device toward the optical imaging device, wherein the light beam incident on the optical imaging device includes P polarized light and S polarized light such that a proportion of P polarized light is greater than a proportion of S polarized light according to an incident angle of the light beam incident on the deflector.

The reflectivity of the optical reflective device may decrease as an incident angle of the light beam incident on the optical reflective device increases.

The reflectivity of the optical reflective device may be represented as follows.

|Rc−Rs|≦10(%)

wherein Rc is a reflectivity at a center portion of the optical reflective device and Rs is a reflectivity at both ends of the optical reflective device.

The optical source may include an edge emitting laser diode including an active layer inclined by a range of 45 degrees to 90 degrees with respect to a sub-scanning direction.

The optical reflective device may include a plane reflecting surface.

Embodiments of the present general inventive concept can also be achieved by providing a laser scanning unit including an optical source to irradiate a light beam, a deflector to deflect the irradiated light beam to a photosensitive body, an optical imaging device on which the light beam deflected from the deflector is incident and which forms an image on the photosensitive body, and an optical reflective device to reflect the deflected light beam transmitted through the optical imaging device toward the optical imaging device, wherein a reflectivity of the optical reflective device increases as an incident angle of the light beam incident on the optical reflective device increases.

The light beam incident on the optical imaging device may include P polarized light and S polarized such that a proportion of the P polarized light is less than a proportion of the S polarized light.

The reflectivity of the optical reflective device may be represented as follows.

|Rc−Rs|≦30(%)

wherein Rc is the reflectivity at a center of the optical reflective device and Rs is the reflectivity at both ends of the optical reflective device.

Embodiments of the present general inventive concept can also be achieved by providing an image-forming apparatus including a laser scanning unit to irradiate a light beam, a photosensitive body on which an electrostatic latent image is formed by the irradiated light beam, a developing unit to develop the electrostatic latent image, and a transfer unit to transfer the image developed by the developing unit, wherein the laser scanning unit includes an optical source to irradiate the light beam, a deflector to deflect the irradiated light beam to the photosensitive body, an optical imaging device on which the light beam deflected from the deflector is incident and which forms an image on the photosensitive body, and an optical reflective device to reflect the deflected light beam transmitted through the optical imaging device toward the optical imaging device, wherein the light beam incident on the optical imaging device includes P polarized light and S polarized light such that a proportion of P polarized light is greater than a proportion of S polarized light according to an incident angle of the light beam incident on the deflector.

Embodiments of the present general inventive concept can also be achieved by providing an image-forming apparatus including a laser scanning unit to irradiate a light beam, a photosensitive body on which an electrostatic latent image is formed by the irradiated light beam, a developing unit to develop the electrostatic latent image, and a transfer unit to transfer the image developed by the developing unit, wherein the laser scanning unit includes an optical source to irradiate the light beam, a deflector to deflect the irradiated light beam to a photosensitive body, an optical imaging device on which the light beam deflected from the deflector is incident and which forms an image on the photosensitive body, and an optical reflective device to reflect the deflected light beam transmitted through the optical imaging device toward the optical imaging device, wherein the reflectivity of the optical reflective device increases as an incident angle of the light beam incident on the optical reflective device increases.

Embodiments of the present general inventive concept can also be achieved by providing a scanning unit including an optical source to irradiate a light beam, a deflector to deflect the irradiated light beam to a photosensitive body, an optical imaging device to transmit at least a portion of the light beam therethrough, and an optical reflective device to reflect the transmitted portion of the light beam through the optical imaging device to form an image on a photosensitive body wherein the optical reflective device has a highest reflectivity at a center portion thereof and a lowest reflectivity at end portions thereof, wherein the lowest reflectivity is less than or equal to 30% of the highest reflectivity.

The optical source may include a laser having a dual light beam.

A first beam of the dual light beam may include P polarized light and a second beam of the dual light beam may include S polarized light.

Each beam of the laser having a dual beam may include P polarized light and S polarized light.

The lowest reflectivity may be less than or equal to 10% of the highest reflectivity.

The optical reflective device may include a protective film on at least one surface of the optical reflective device which may have a thickness of between about 450 nm and 800 nm.

Embodiments of the present general inventive concept can also be achieved by providing an image forming apparatus including a laser scanning unit including an optical source to irradiate a light beam, a deflector to deflect the irradiated light beam to a photosensitive body, an optical imaging device to transmit at least a portion of the light beam therethrough, and an optical reflective device to reflect the transmitted portion of the light beam through the optical imaging device to form an image on a photosensitive body wherein the optical reflective device has a highest reflectivity at a center portion thereof and a lowest reflectivity at end portions thereof, wherein the lowest reflectivity is less than or equal to 30% of the highest reflectivity.

The lowest reflectivity may be less than or equal to 10% of the highest reflectivity.

The image forming unit may further include a developing unit to develop the image, and a transfer unit to transfer the image developed by the image to a printing medium.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings, of which:

FIG. 1 illustrates a plan view of a laser scanning unit according to exemplary embodiments of the present general inventive concept;

FIG. 2 illustrates a side view of the laser scanning unit of FIG. 1;

FIG. 3 illustrates a relationship between an incident plane and a deflected direction of a light beam;

FIG. 4 is a graph illustrating a brightness ratio according to a position of the imaging plane of an optical imaging device of a laser scanning unit according to exemplary embodiments of the present general inventive concept when a light beam is transmitted through the optical imaging device once;

FIG. 5 is a graph illustrating a brightness ratio according to a position of the imaging plane of an optical imaging device of a laser scanning unit according to exemplary embodiments of the present general inventive concept when a light beam is transmitted through the optical imaging device twice;

FIG. 6 is a graph illustrating reflectivity according to an incident angle of a light beam incident on an optical imaging device of a laser scanning unit according to exemplary embodiments of the present general inventive concept;

FIG. 7 is a graph illustrating reflectivity according to an incident angle of a light beam emitted to air from an optical imaging device of a laser scanning unit according to exemplary embodiments of the present general inventive concept;

FIGS. 8A through 8C illustrate changes in a deflected direction according to an inclination of an optical source in a laser scanning unit according to exemplary embodiments of the present general inventive concept;

FIG. 9 is a graph illustrating a change in reflectivity according to an incident angle of light incident on an optical reflective device in a laser scanning unit according to exemplary embodiments of the present general inventive concept;

FIG. 10 is a graph illustrating a change in reflectivity according to an incident angle of light incident on an optical reflective device according to exemplary embodiments of the present general inventive concept;

FIG. 11 is a diagram illustrating a laser scanning unit according to exemplary embodiments of the present general inventive concept; and

FIG. 12 is a diagram illustrating an image-forming apparatus according to exemplary embodiments of the present general inventive concept.

### DETAILED DESCRIPTION OF THE EMBODIMENTS

Reference will now be made in detail to the exemplary embodiments of the present general inventive concept, examples of which are illustrated in the accompanying drawings, wherein like reference numerals refer to like elements throughout. The exemplary embodiments are described below in order to explain the present general inventive concept by referring to the figures.

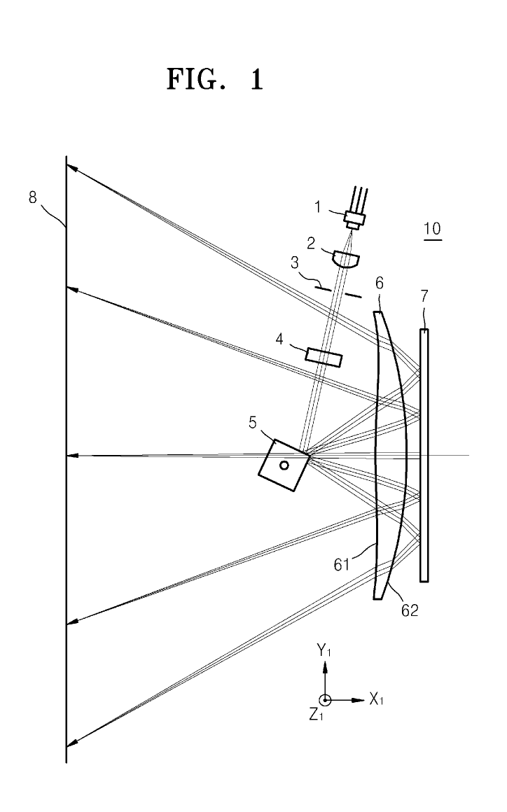

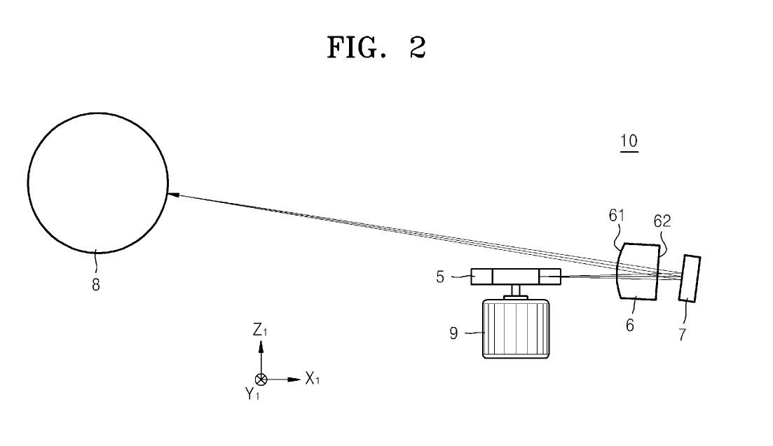

FIG. 1 illustrates a plan view of a laser scanning unit 10 according to exemplary embodiments of the present general inventive concept and FIG. 2 illustrates a side view of the laser scanning unit 10.

Referring to FIGS. 1 and 2, the laser scanning unit 10 according to the present exemplary embodiment includes an optical source 1 to irradiate a light beam and a deflector 5 to deflect the light beam irradiated from the optical source 1 to a photosensitive body 8. The optical source 1 may include, but is not limited to, a laser, a laser diode, a gas laser, a DPSS laser, a semiconductor laser, and the like. The deflector 5 may be, for example, a polygonal mirror rotated by a motor 9.

A collimating lens 2 and a cylindrical lens 4 may be disposed on an optical path between the optical source 1 and the deflector 5, wherein the collimating lens 2 converts the light beam emitted from the optical source 1 into a parallel beam and the cylindrical lens 4 focuses the light beam on a deflecting surface of the deflector 5. The cylindrical lens 4 focuses the light beam in a sub-scanning direction and forms a line-form image on the deflecting surface of the deflector 5. As the deflector 5 is rotated, the light beam is scanned to the photosensitive body 8 in a main scanning direction and as the photosensitive body 8 moves, scan lines are moved in the sub-scanning direction. In FIGS. 1 and 2, a direction Y₁ denotes the main scanning direction and a direction Z₁ denotes the sub-scanning direction. An aperture stop 3 may be interposed between the collimating lens 2 and the cylindrical lens 4.

The deflector 5 may irradiate the light beam on an optical imaging device 6 to form an image on the photosensitive body 8. The optical imaging device 6 may be disposed on an optical path between the deflector 5 and the photosensitive body 8. An optical reflective device 7 may be disposed on an optical path between the optical imaging device 6 and the photosensitive body 8. The optical reflective device 7 reflects the light beam transmitted through the optical imaging device 6 back toward the optical imaging device 6 and thus the optical path is folded. The light beam reflected from the optical reflective device 7 is transmitted back through the optical imaging device 6 and forms an image on the photosensitive body 8. In other words, the light beam is transmitted through the optical imaging device 6 in a first direction, reflects off of the optical reflective device 7, and is transmitted through the optical imaging device 6 in a direction opposite to the first direction to form an image on the photosensitive body 8.

The optical imaging device 6 may include a first surface 61, on which the light beam reflected from the deflector 5 is incident, and a second surface 62, which faces the first surface 61. The light beam reflected from the optical reflective device 7 may be incident on the second surface 62 and may be transmitted through the first surface 61.

In the laser scanning unit 10 according to the present exemplary embodiment, the light beam may be transmitted through the optical imaging device 6 twice. For example, the light beam may be transmitted through the first surface 61 and the second surface 62 of the optical imaging device 6 as a first transmission through the optical imaging device 6, and the light beam may reflect off of the optical reflective device 7 and be transmitted through the second surface 62 and the first surface 61 of the optical imaging device 6 as a second transmission through the optical imaging device. A brightness ratio is a reference value for comparing relative brightness values at various positions along a width W of an imaging plane with a brightness value at a center of the imaging plane having a brightness ratio expressed as 1.0. The brightness ratio may vary in the photosensitive body 8 due to a variance of a quantity of light penetration in the main scanning direction of the optical imaging device 6. Such variance of the brightness ratio is affected according to the type of polarized light of the light beam incident on the optical imaging device 6.

Hereinafter, the variance of a brightness ratio according to polarized light of the light beam will be described.

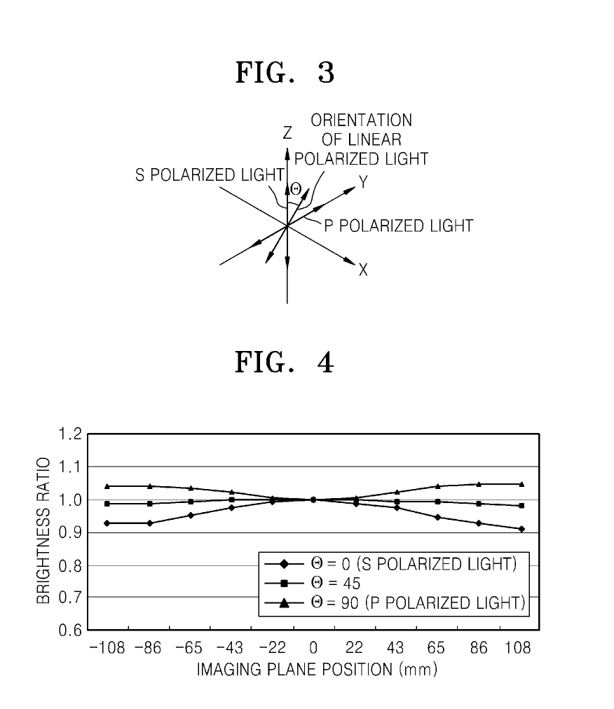

FIG. 3 illustrates the relationship between an incident plane and a deflected direction of the light beam. Referring to FIG. 3, a property of polarized light according to an oscillation direction of the light beam is illustrated when an X-Y plane constitutes an incident plane of the light beam. When the polarized light of the light beam is parallel to the incident plane of the deflector 5, the polarized light is denoted as P polarized light. When the polarized light of the light beam is perpendicular to the incident plane, the polarized light is denoted as S polarized light. As illustrated in FIG. 3, Θ denotes an orientation of the polarized light expressed as an angle between the X-Y plane and a Z direction. In FIG. 3, the X-Y plane is the incident plane. When the polarized direction is parallel to the Z direction, or in other words, perpendicular to the X-Y plane, the polarized light is the S polarized light and when the polarized light direction is parallel to a Y direction, the polarized light is the P polarized light.

FIG. 4 is a graph illustrating a brightness ratio according to a position of an imaging plane of the optical imaging device 6 when the light beam is transmitted through the optical imaging device 6 once. The imaging plane may refer to a surface of the photosensitive body 8. The brightness ratio at the center of the imaging plane is denoted as 1.0 and the brightness ratio in exemplary positions along the width W of the imaging plane is illustrated in FIG. 4. The brightness ratio at the center of the imaging plane is a reference value for comparing relative values in each position, instead of an absolute value. When the polarized light is the S polarized light (Θ=0) based on the incident plane of the reflecting surface of the deflector 5 and the brightness ratio at the center of the imaging plane is 1.0, the brightness ratio at both ends of the imaging plane is approximately 0.93 and is less than the brightness ratio at the center of the imaging plane. When the polarized light is the P polarized light (Θ=90 degrees), the brightness ratio at both ends of the imaging plane is approximately 1.05 and is greater than the brightness ratio at the center of the imaging plane. When Θ is 45 degrees, the brightness ratio is uniformly distributed according to the position of the imaging plane. As illustrated in the graph of FIG. 4, the brightness ratio in the imaging plane of the optical imaging device 6 varies according to a polarization of the light beam incident on the optical imaging device 6.

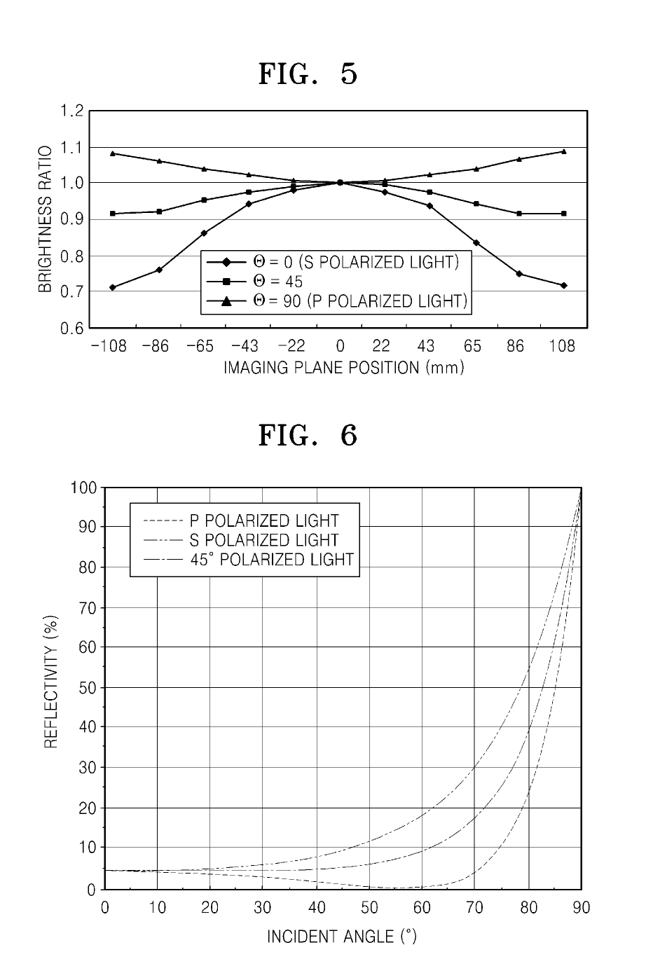

FIG. 5 is a graph illustrating a brightness ratio according to a position of the imaging plane of the optical imaging device 6 when the light beam is transmitted through the optical imaging device 6 twice. When the orientation Θ of the polarized light is 45 degrees and 90 degrees, a variation of less than 10% is shown in the brightness ratio at both ends of the imaging plane of the optical imaging device 6, compared with that at the center of the imaging plane, whereas when the orientation Θ of the polarized light is 0 degrees, a variation of greater than 10% is shown in the brightness ratio at both ends of the imaging plane, compared with that at the center of the imaging plane. Such a variance of the brightness ratio deteriorates uniformity of image density and thus, image quality. Referring to FIGS. 4 and 5, the variation of the brightness ratio is not significant when the orientation Θ of the polarized light is greater than 45 degrees compared to when the orientation Θ of the polarized light is less than 45 degrees. Accordingly, in the laser scanning unit 10, the light beam incident on the optical imaging device 6 has a higher proportion of P polarized light than S polarized light in order to increase uniformity of the brightness ratio. When the orientation Θ of the polarized light of the light beam incident on the optical imaging device 6 is greater than 45 degrees, the light beam incident on the optical imaging device 6 has a higher proportion of P polarized light than S polarized light.

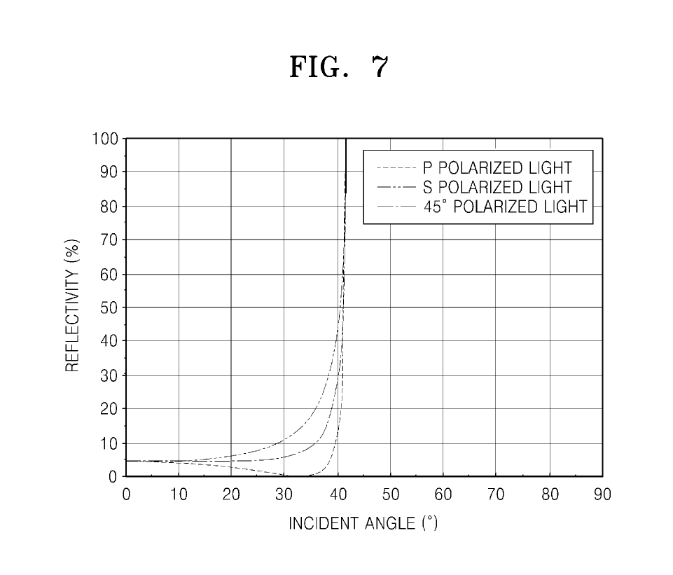

FIGS. 4 and 5 illustrate that incident angles of the light beam incident on the optical imaging device 6 are different in each position along the width W of the optical imaging device 6. Reflectivity based on the incident angle of the light beam is changed according to the orientation Θ of the polarized light, as will be described with reference to FIGS. 6 and 7. FIG. 6 is a graph illustrating reflectivity according to an incident angle of the light beam for each orientation of the polarized light of the light beam when the light beam is incident on the optical imaging device 6, and FIG. 7 is a graph illustrating reflectivity according to an incident angle of the light beam for each orientation of the polarized light of the light beam when the light beam is emitted to air from the optical imaging device 6. The light beam may be considered as being emitted to air when the light beam passes through the second surface 62 of the optical imaging device 6 toward the optical reflective device 7, and when the light beam passes through the first surface 61 of the optical imaging device 6 toward the photosensitive body 8. In other words, the light beam may be considered as being emitted to air when a light beam is transmitted toward the optical reflective device 7 after the light beam has passed through the second surface 62 of the optical imaging device 6, and when the light beam is transmitted toward the photosensitive body 8 after the light beam has passed through the first surface 61 of the optical imaging device 6.

When the light beam is transmitted through the optical imaging device 6 twice, four interfacial reflections occur. The interfacial reflections include first through fourth reflections, wherein the first reflection occurs when the light beam is incident on the first surface 61 of the optical imaging device 6, the second reflection occurs when the light beam is emitted to the air through the second surface 62 of the optical imaging device 6, the third reflection occurs when the light beam is reflected from the optical reflective device 7 and is incident on the second surface 62 of the optical imaging device 6, and the fourth reflection occurs when the light beam is emitted to the air through the first surface 61 of the optical imaging device 6. The reflectivity at the center of the optical imaging device 6 and at both ends of the optical imaging device 6 is estimated with reference to FIGS. 6 and 7.

When the light beam irradiated from the optical source 1 is S polarized light, an example of the reflectivity may be expressed as follows. The incident angle of the light incident on the center portion of the optical imaging device 6, which is adjacent to an optical axis, is approximately less than 5 degrees. Referring to FIG. 6, when the incident angle of the light is less than 5 degrees, the reflectivity of the S polarized light during the first reflection is about 4.2%. When the light is emitted from the optical imaging device 6 to the air, the incident angle of the light incident on the second surface 62 is approximately less than 5 degrees and the reflectivity of the S polarized light during the second reflection is about 4.2%. When the incident angles during the third and fourth reflections are less than 5 degrees, the reflectivity is about 4.2%. In this example, the total reflectivity, aside from scattering on the surface of the optical imaging device 6, occurring in the optical imaging device 6 due to the Fresnel Equations is about 16% and transmissivity is about 84%. In other words, about 16% of the light beam is reflected off of the optical imaging device 6, and about 84% of the light beam is transmitted through the optical imaging device 6, when the light beam is incident on the center portion of the optical imaging device 6.

The reflectivity at both ends of the optical imaging device 6 with respect to the S polarized light is calculated as follows. For example, the incident angles when the first through fourth reflections occur at both ends of the optical imaging device 6 may be respectively about 66 degrees, 29 degrees, 50 degrees, and 4 degrees, and the reflectivity may be calculated. The first reflection and the third reflection are calculated with reference to the graph illustrated in FIG. 4. The second reflection and the fourth reflection are calculated with reference to the graph illustrated in FIG. 5. When the incident angle is about 66 degrees, the reflectivity of the first reflection of the S polarized light is about 24%, as illustrated in FIG. 6. When the incident angle is about 29 degrees, the reflectivity of the second reflection of the S polarized light is about 11%, as illustrated in FIG. 7. When the incident angle is about 50 degrees, the reflectivity of the third reflection of the S polarized light is about 11%, as illustrated in FIG. 6. When the incident angle is about 4 degrees, the reflectivity of the fourth reflection of the S polarized light is about 4.2%, as illustrated in FIG. 7. When the S polarized light is transmitted through both ends of the optical imaging device 6 twice, the total reflectivity, i.e., the sum of the reflectivity of the first through fourth reflections, is about 50% and the total transmissivity is about 50%. According to the above calculation, when the light irradiated from the optical source 1 is S polarized light, the difference in the reflectivity between the center of the optical imaging device 6 and both ends of the optical imaging device 6 after the light is transmitted through the optical imaging device 6 twice may be about 34%. In other words, about 16% of the light beam may be reflected off of the center portion of the optical image device 6, while about 50% of the light beam may be reflected off of both ends of the optical image device 6.

When the light beam irradiated from the optical source 1 is P polarized light, the reflectivity according to the first through fourth reflections may be calculated in a similar manner as exemplified above with regard to S polarized light. In this example, the incident angles at the center of the optical imaging device 6 during the first through fourth reflections are less than 5 degrees. As illustrated in FIGS. 4 and 5, the total reflectivity of P polarized light at incident angles of less than 5 degrees is approximately the same as that of the S polarized light as the same incident angles. In other words, the total reflectivity at the center of the optical imaging device 6 with respect to the P polarized light at incident angles of less than 5 degrees may be about 16%.

The reflectivity at both ends of the optical imaging device 6 with respect to the P polarized light may be calculated in a similar manner as exemplified above with regard to S polarized light. In this example, it is assumed that the incident angles when the first through the fourth reflections occur at both ends of the optical imaging device 6 are respectively about 66 degrees, 29 degrees, 50 degrees, and 4 degrees, and the reflectivity is calculated.

Referring to FIGS. 6 and 7, when the incident angles with respect to the P polarized light are respectively about 66 degrees, 29 degrees, 50 degrees, and 4 degrees, first reflectivity, second reflectivity, third reflectivity, and fourth reflectivity are respectively 2%, 0.5%, 0.5%, and 4.2%. Since the reflectivity at Brewster's angle with respect to the P polarized light is almost 0, the reflectivity is lower than that of the S polarized light. According to the above exemplary calculation, the total reflectivity at the ends of the optical imaging device 6 with respect to the P polarized light may be about 7% and is lower than the reflectivity at the center of the optical imaging device 6 with respect to the P polarized light by about 9%. A reflectivity variation at the center and ends of the optical imaging device 6 with respect to the P polarized light is less than that of the S polarized light. The above calculations of the reflectivity and transmissivity according to the exemplary incident angles with respect to the P polarized light and the S polarized light are examples provided to illustrate that there is a difference in reflection properties according to the P polarized light and the S polarized light.

Referring to FIGS. 6 and 7, the reflectivity of the P polarized light is reduced as the incident angle of the light beam increases, and increases when the incident angle is above a specific value. The reflectivity of the S polarized light increases as the incident angle of the light beam increases. The reflectivity of 45 degree polarized light remains relatively stable until the incident angle of the light beam exceeds about 45 degrees, at which point the reflectivity gradually increases. Accordingly, the reflectivity of 45 degree polarized light or less increases, as the incident angle increases. When the light beam is transmitted through the optical imaging device 6 twice, the variation of the brightness ratio with respect to the P polarized light (Θ=90 degrees) is less than the variation of the brightness ratio with respect to the S polarized light (Θ=0 degree) as illustrated in FIGS. 4 and 5. Thus, in order to reduce the variation of the brightness ratio, the light beam may have a higher proportion of P polarized light than S polarized light. When this principle is applied to the laser scanning unit 10 illustrated in FIG. 1, the orientation of the P polarized light corresponds to the main scanning direction and the orientation of the S polarized light corresponds to the sub-scanning direction. According to the present exemplary embodiment, the light beam has a higher proportion of polarized light in the main scanning direction, which corresponds to P polarized light, than that in the sub-scanning direction, which corresponds to S polarized light, and thus the variation of the brightness ratio at an imaging plane may be reduced. In other words, when an angle between the orientation of the polarized light of the optical source 1 and the sub-scanning direction is θ, the orientation of the polarized light of the optical source 1 may be in a range of 45≦θ≦90.

For example, the light beam emitted from the optical source 1 and incident on the optical imaging device 6 may be adjusted to have a higher proportion of polarized light in the main scanning direction than polarized light in the sub-scanning direction.

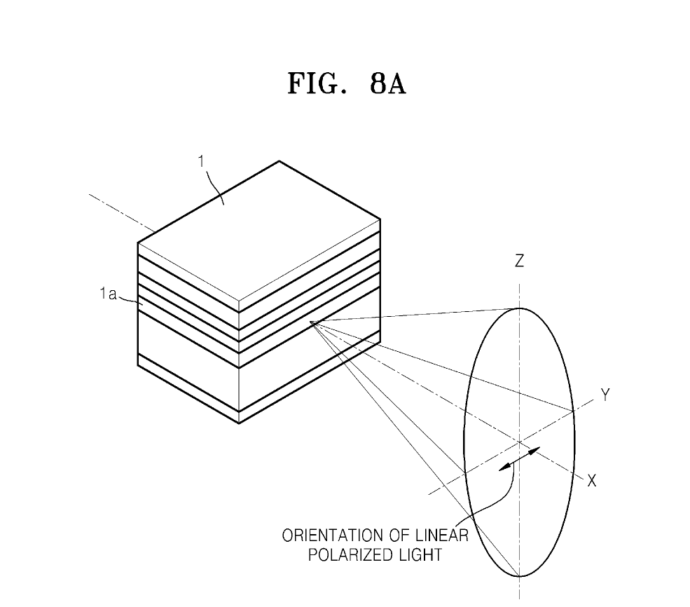

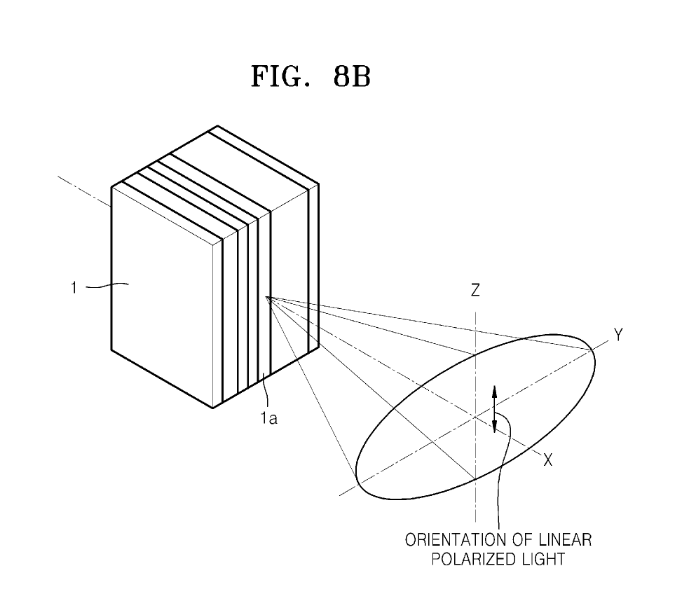

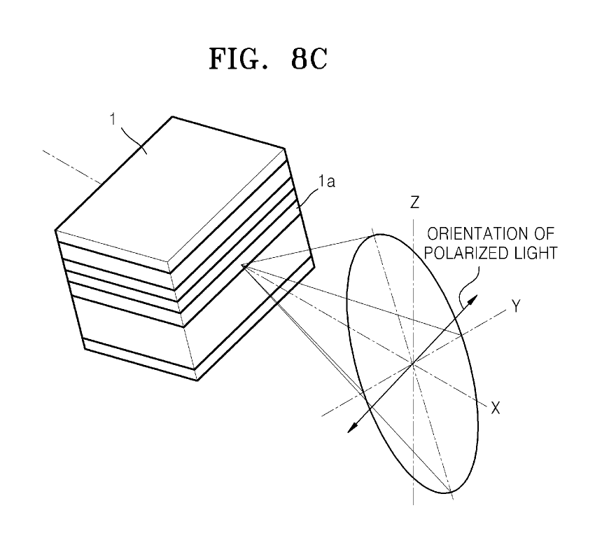

FIGS. 8A through 8C illustrate changes in a deflected direction according to an inclination of the optical source 1 in the laser scanning unit 10 according to exemplary embodiments of the present general inventive concept. Referring to FIG. 8A, an edge emitting laser diode may be used as the optical source 1. The edge emitting laser diode may be formed of a plurality of layers including an active layer 1A. The edge emitting laser diode may emit light from the edge of the active layer 1A, wherein the light is polarized in a direction parallel to the active layer 1A. Referring to FIG. 8A, when an X-Y plane constitutes an incident plane of the optical imaging device 6, the light beam irradiated from the optical source 1 oscillates in a direction parallel to the incident, or X-Y, plane and thus P polarized light is emitted. In FIG. 8B, the optical source 1 is disposed in such a way that the active layer 1A formed therein is parallel to a Z-axis, and when the X-Y plane constitutes an incident plane of the optical imaging device 6, S polarized light is emitted from the optical source 1. In FIG. 8C, the optical source 1 is disposed in such a way that the active layer 1A is inclined by θ with respect to the X-Y plane, and the light beam emitted from the optical source 1 is polarized in the θ direction.

As described above, inclination of the active layer 1A of the optical source 1 may be adjusted so that the light emitted from the active layer 1 and incident on the optical imaging device 6 has a higher proportion of P polarized light than S polarized light. The adjustment of the orientation of the polarized light of the light beam emitted from the optical source 1 may be performed using various known methods.

In the laser scanning unit 10 according to the present exemplary embodiment, the optical path may be folded due to the inclusion of the optical reflective device 7 and thus a space to install the laser scanning unit 10 may be miniaturized. The optical reflective device 7 may have a plane reflecting surface.

According to exemplary embodiments, the reflectivity according to an incident angle of the beam with respect to the optical reflective device 7 is adjusted to improve uniformity of the brightness ratio on an image forming surface of the optical reflective device 7 which reflects the light beam toward the photosensitive body 8 to form an image thereon.

Referring to FIG. 5, for example, when the light beam from the optical source 1 is P polarized light, about 9% variance of the brightness ratio after the light beam is transmitted through the optical imaging device 6 twice may occur since the brightness ratio of P polarized light at the center of the imaging plane is about 1.0, and the brightness ratio of P polarized light at the ends of the imaging plane is about 1.09. In order to reduce the variance of the brightness ratio, the reflectivity may be adjusted to offset the variance of the brightness ratio the optical reflective device 7 occurring due to the optical imaging device 6. When the light beam incident on the optical imaging device 6 is P polarized light, the brightness ratio generated in the optical imaging device 6 may be increased by about 9% at left and right ends of the optical imaging device 6, compared with at the center of the optical imaging device 6. As the reflectivity at left and right ends of the optical imaging device 6 is reduced, the variance of the brightness ratio in an image may be consequently uniform. When the light beam incident on the optical imaging device 6 has a higher proportion of P polarized light than S polarized light, the reflectivity at the center of the optical reflective device 7 may be referred to as Rc and the reflectivity at both ends of the optical reflective device 7 may be referred to as Rs. The reflectivity of the optical reflective device 7 when the light beam incident on the optical imaging device 6 has a higher proportion of P polarized light than S polarized light may be expressed by the following equation:

|Rc−Rs|≦10(%) [Equation 1]

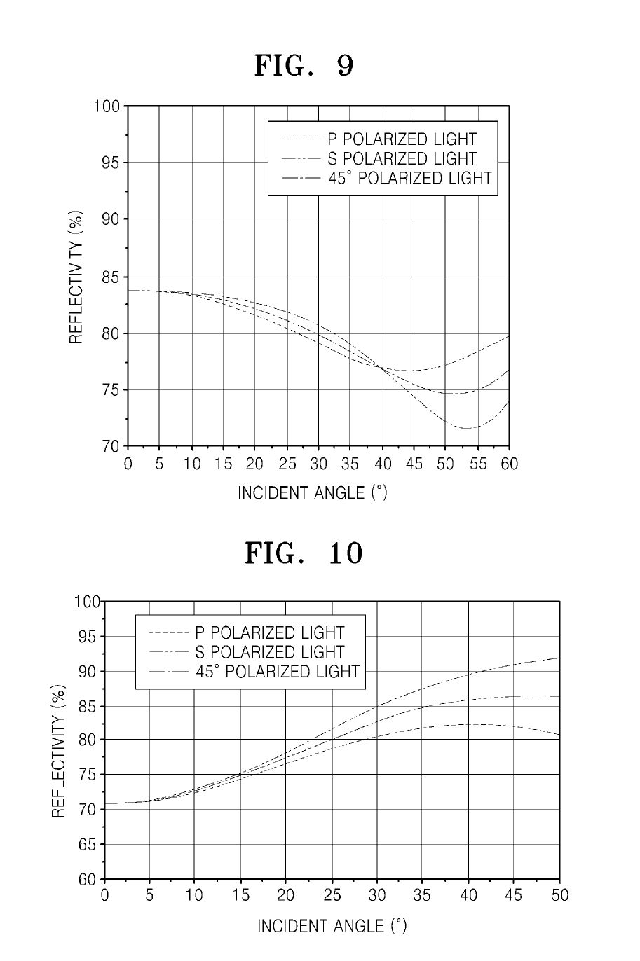

FIG. 9 is a graph illustrating the reflectivity according to an incident angle of light incident on the optical reflective device 7. The optical reflective device 7 may include a glass layer, an Al layer coated on the glass layer and SiO₂ coated on the Al layer as a protection film. The thickness of the protection film may be about 460 nm. In the present example, the incident angle of the light beam incident on the optical reflective device 7 may be about 5 degrees at the center of the optical reflective device 7 and about 26 degrees at both ends of the optical reflective device 7. When the incident angle is 5 degrees, the reflectivity is about 84% and when the incident angle is 26 degrees, the reflectivity is about 81%. As the incident angle increases, the reflectivity reduces. The reflectivity of the optical reflective device 7 may be adjusted by adjusting the thickness of each layer in the optical reflective device 7. In other words, the thickness of each layer in the optical reflective device 7 may be increased or decreased so that the optical reflective device 7 may have a reflection property whereby the reflectivity increases as the incident angle of the beam increases. The optical reflective device 7 may also have a reflection property whereby the reflectivity decreases as the incident angle of the beam decreases.

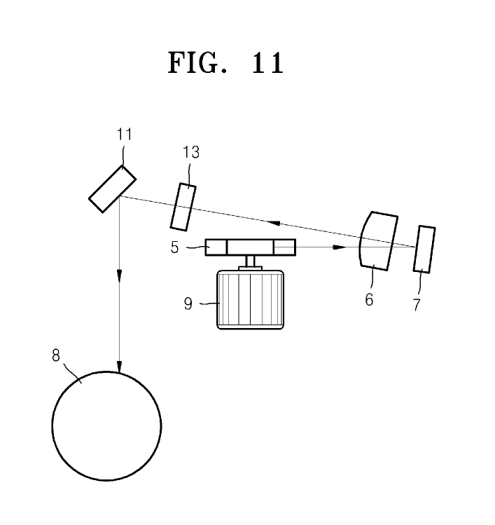

The optical source may be a laser diode using a dual beam, where the dual beam may have a higher proportion of S polarized light than P polarized light in order to realize a desired pitch in an image region by sub-scanning magnification. Each beam of the dual beam laser diode may include one of or both S polarized light and P polarized light. The light beam transmitted through the optical imaging device 6 twice may have a variation in brightness ratio of 10% or more, thereby deteriorating brightness ratio uniformity, as illustrated in FIG. 5. The reflectivity of the optical reflective device 7 may be adjusted to offset the variance of the brightness ratio occurring in the optical imaging device 6. For example, the variance of the brightness ratio occurring in the optical imaging device 6 with respect to the S polarized light may be about 30%, as illustrated in FIG. 5. In order to offset the variance of the brightness ratio, the optical reflective device 7 having the reflection property whereby the reflectivity increases as the incident angle of the beam increases, may be used as illustrated in FIG. 10, to reduce the variance of the brightness ratio.

FIG. 10 is a graph illustrating reflectivity according to an incident angle of light incident on an optical reflective device according to exemplary embodiments of the present general inventive concept.

In FIG. 10, the reflective property of the optical reflective device according to the present exemplary embodiment is illustrated. The optical reflective device 7 according to the present exemplary embodiment may be manufactured by coating Al on a glass layer, coating SiO₂ on the Al layer to a thickness of 278 nm, coating TiO₂ on the SiO₂ layer to a thickness of 203 nm, and coating SiO₂ on the TiO₂ layer to a thickness of 292 nm. In such an optical reflective device 7, the brightness ratio at both ends is higher by about 20% than that of at the center of the optical reflective device 7. Accordingly, the variance of the brightness ratio occurring in the optical imaging device with respect to S polarized light is offset through the optical reflective device, thereby improving uniformity of the brightness ratio.

When the light beam incident on the optical imaging device has a higher proportion of S polarized light than P polarized light, the reflectivity of the optical reflective device may be adjusted to satisfy the equation below so as to reduce the variance of the brightness ratio. The reflectivity of the optical reflective device 7 when the light beam incident on the optical imaging device 6 has a higher proportion of S polarized light than P polarized light may be expressed by the following equation:

|Rc−Rs|≦30(%) [Equation 2]

In Equation 2, Rc refers to the reflectivity at the center portion of the optical reflective device and Rs refers to the reflectivity at both ends.

FIG. 11 is a diagram illustrating the laser scanning unit 10 according to exemplary embodiments of the present general inventive concept.

Referring to FIG. 11, the laser scanning unit 10 of FIG. 1 may further include at least one reflection mirror 11 on the optical path between the optical imaging device 6 and the photosensitive body 8. The optical path may be altered using the at least one reflection mirror 11 and thus the space in which the laser scanning unit 10 is accommodated may be reduced. A lens 13 may be interposed between the optical imaging device 6 and the reflection mirror 11.

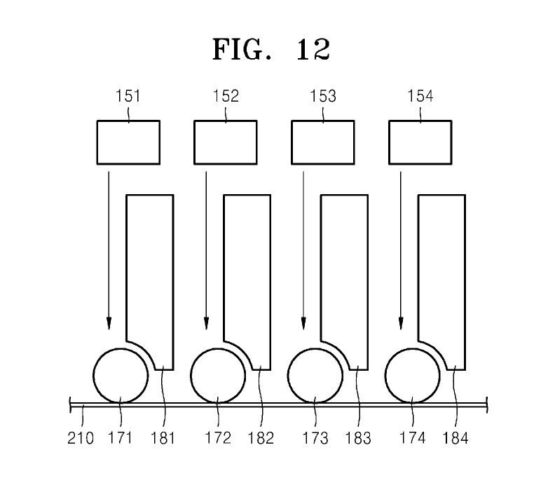

FIG. 12 is a diagram illustrating an image-forming apparatus according to exemplary embodiments of the present general inventive concept.

Referring to FIG. 12, the image-forming apparatus according to the present exemplary embodiment may include first through fourth laser scanning units 151, 152, 153, and 154 to form electrostatic images having different colors. The first through fourth laser scanning units 151, 152, 153, and 154 may have the same configuration as the laser scanning unit 10 described with reference to FIGS. 1 and 2 and thus detailed descriptions thereof are not repeated here.

The image-forming apparatus may include first through fourth photosensitive bodies 171, 172, 173, and 174. The first through fourth laser scanning units 151, 152, 153, and 154 irradiate light to the first through fourth photosensitive bodies 171, 172, 173, and 174. First through fourth developing units 181, 182, 183, and 184 may be formed on the first through fourth photosensitive bodys 171, 172, 173, and 174 to develop electrostatic latent images respectively thereon. The image-forming apparatus may include a transfer unit 210 to transfer the developed image to a printing medium. The first through fourth laser scanning units 151, 152, 153, and 154 may control the light beam to be in an on or off state according to an image signal received from an external device and may irradiate the light beam when the light beam is in an on state. The light beam may irradiated to the first through fourth photosensitive bodys 171, 172, 173, and 174 through the deflector 5 to form the electrostatic latent images having different colors.

Developers may be respectively supplied to the first through fourth photosensitive bodys 171, 172, 173, and 174 from the first through fourth developing units 181, 182, 183, and 184, to develop the electrostatic latent images having different colors. The images may be sequentially transferred to the transfer unit 210 to form a color image. For example, a first line transferred to the transfer unit 210 from the first photo sensitizer 171, a second line transferred from the second photo sensitizer 172, a third line transferred from the third photo sensitizer 173, and a fourth line transferred from the fourth photo sensitizer 174 may be sequentially overlapped to form a color image and then fixed to the printing medium, such as paper. The laser scanning unit according to the present general inventive concept may be applied to other image-forming apparatuses in a manner similar to that describe above, in addition to the image-forming apparatus of FIG. 12 according to the present exemplary embodiment.

The laser scanning unit according to the present general inventive concept may be applied to electrophotographic image-forming apparatuses which form images on printing media, such as photocopiers, printers, and facsimile machines.

According to the present general inventive concept, uniform brightness ratio is realized in order to obtain high quality images. The optical reflective device according to the present general inventive concept is used to adjust the optical path from the optical source to the photosensitive body so as to miniaturize the laser scanning unit.

Although several embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A laser scanning unit comprising:
an optical source to irradiate a light beam;
a deflector to deflect the irradiated light beam to a photosensitive body;
an optical imaging device on which the light beam deflected from the deflector is incident and which forms an image on the photosensitive body; and
an optical reflective device to reflect the deflected light beam transmitted through the optical imaging device toward the optical imaging device,
wherein the light beam incident on the optical imaging device includes P polarized light and S polarized light such that a proportion of P polarized light is greater than a proportion of S polarized light according to an incident angle of the light beam incident on the deflector.

2. The laser scanning unit of claim 1, wherein the reflectivity of the optical reflective device decreases as an incident angle of the light beam incident on the optical reflective device increases.

3. The laser scanning unit of claim 2, wherein the reflectivity of the optical reflective device is represented as follows.

|Rc−Rs|≦10(%)
wherein Rc is a reflectivity at a center portion of the optical reflective device and Rs is a reflectivity at both ends of the optical reflective device.

4. The laser scanning unit of claim 1, wherein the optical source comprises:
an edge emitting laser diode including an active layer inclined by a range of 45 degrees to 90 degrees with respect to a sub-scanning direction.

5. The laser scanning unit of claim 1, wherein the optical reflective device includes a plane reflecting surface.

6. A laser scanning unit comprising:
an optical source to irradiate a light beam;
a deflector for deflecting the irradiated light beam to a photosensitive body;
an optical imaging device on which the light beam deflected from the deflector is incident and which forms an image on the photosensitive body; and
an optical reflective device to reflect the deflected light beam transmitted through the optical imaging device toward the optical imaging device,
wherein a reflectivity of the optical reflective device increases as an incident angle of the light beam incident on the optical reflective device increases.

7. The laser scanning unit of claim 6, wherein the light beam incident on the optical imaging device includes P polarized light and S polarized light such that a proportion of P polarized light is less than a proportion of S polarized light.

8. The laser scanning unit of claim 6, wherein the reflectivity of the optical reflective device is represented as follows.

|Rc−Rs|≦30(%)
wherein Rc is the reflectivity at the center of the optical reflective device and Rs is the reflectivity at both ends of the optical reflective device.

9. The laser scanning unit of claim 6, wherein the optical reflective device includes a plane reflecting surface.

10. An image-forming apparatus comprising:
a laser scanning unit to irradiate a light beam;
a photosensitive body on which an electrostatic latent image is formed by the irradiated light beam;
a developing unit to develop the electrostatic latent image; and
a transfer unit to transfer the image developed by the developing unit,
wherein the laser scanning unit comprises:
an optical source to irradiate the light beam;
a deflector to deflect the irradiated light beam to the photosensitive body;
an optical imaging device on which the light beam deflected from the deflector is incident and which forms the electrostatic latent image on the photosensitive body; and
an optical reflective device to reflect the deflected light beam transmitted through the optical imaging device toward the optical imaging device,
wherein the light beam incident on the optical imaging device includes P polarized light and S polarized light such that a proportion of P polarized light is greater than a proportion of S polarized light according to an incident angle of the light beam incident on the deflector.

11. The apparatus of claim 10, wherein the optical source comprises:
an edge emitting laser diode including an active layer inclined by a range of 45 degrees to 90 degrees with respect to a sub-scanning direction.

12. The apparatus of claim 10, wherein the optical reflective device includes a plane reflecting surface.

13. An image-forming apparatus comprising:
a laser scanning unit to irradiate a light beam;
a photosensitive body on which an electrostatic latent image is formed by the irradiated light beam;
a developing unit to develop the electrostatic latent image; and
a transfer unit to transfer the image developed by the developing unit,
wherein the laser scanning unit comprises
an optical source to irradiate the light beam;
a deflector to deflect the irradiated light beam to the photosensitive body;
an optical imaging device on which the light beam deflected from the deflector is incident and which forms the electrostatic latent image on the photosensitive body; and
an optical reflective device to reflect the deflected light beam transmitted through the optical imaging device toward the optical imaging device,
wherein a reflectivity of the optical reflective device increases as an incident angle of the light beam incident on the optical reflective device increases.

14. The apparatus of claim 13, wherein the reflectivity of the optical reflective device is represented as follows.

|Rc−Rs|≦30(%)
wherein Rc is the reflectivity at the center of the optical reflective device and Rs is the reflectivity at both ends of the optical reflective device.

15. A scanning unit, comprising:
an optical source to irradiate a light beam;
a deflector to deflect the irradiated light beam to a photosensitive body;
an optical imaging device to transmit at least a portion of the light beam therethrough; and
an optical reflective device to reflect the transmitted portion of the light beam through the optical imaging device to form an image on a photosensitive body wherein the optical reflective device has a highest reflectivity at a center portion thereof and a lowest reflectivity at end portions thereof, wherein the lowest reflectivity is less than or equal to 30% of the highest reflectivity.

16. The scanning unit of claim 15, wherein the dual light beam includes P polarized light and S polarized light in a proportion greater than the P polarized light.

17. An image-forming apparatus, comprising:
a laser scanning unit including:
an optical source to irradiate a light beam;
a deflector to deflect the irradiated light beam to a photosensitive body;
an optical imaging device to transmit at least a portion of the light beam therethrough; and
an optical reflective device to reflect the transmitted portion of the light beam through the optical imaging device to form an image on a photosensitive body and having a highest reflectivity at a center portion thereof and a lowest reflectivity at end portions thereof, wherein the lowest reflectivity is less than or equal to 30% of the highest reflectivity; and
an image forming unit including the photosensitive body to form the image thereon.

18. The image forming unit of claim 17, wherein the optical source includes a laser having a dual light beam and the dual light beam includes P polarized light and S polarized light in a proportion greater than that of the P polarized light, wherein the reflectivity of the optical reflective device increases as an incident angle of the dual light beam incident on the optical reflection device increases.
